(19) United States
(12) Patent Application Publication
(10) Pub. No.: US 2012/0105807 A1
(43) Pub. Date: May 3, 2012

(54) Laser projector compatible with wavelength multiplexing passive filter techniques for stereoscopic 3D

(76) Inventors: David James Volpe, West Milford, NJ (US); Christopher Michael Volpe, Fort Worth, TX (US)

(21) Appl. No.: 12/925,868

(22) Filed: Oct. 30, 2010

(51) Int. Cl. G02B 27/22; G03B 21/14

(52) U.S. Cl. 353/7; 359/464

(57) ABSTRACT

A laser projector compatible with wavelength multiplexing passive filter techniques comprises a scanning system and a plurality of laser systems, wherein each output beam of light has a unique wavelength and is similar in hue to at least one other output beam of light, wherein the output beam of light is received and deflected by a scanning system to produce stereoscopic 3D images on a projection surface. The integrity of the inherent properties of coherent laser light sources, in particular collimation, monochromacity, and speckle, is maintained, contributing to the unique appearance of the resulting stereoscopic images.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND

1. Field

This application relates to laser light displays, specifically to a laser projector for stereoscopic image representation with vector graphics.

2. Prior Art

A laser light show is a visual display wherein substantially collimated beams of coherent light generated by one or more laser sources are projected aerially or scanned in two dimensions, usually with oscillating mirrors, to produce visible images on a projection surface. Differing substantially from conventional cinema and video area-filling displays, laser light show images typically consist of high-contrast outline renderings and silhouettes. Images are produced by a vector graphics scanning method and retain the distinguishing properties of coherent laser light, namely its collimation, monochromacity, or pure hue(s), and its fine interference patterns, or speckle.

A laser light show is substantially different from another and unrelated vein of investigation that uses lasers to replace halogen and xenon light sources in conventional cinema and video area-filling projection systems, the singular goal of which is to enhance the brightness of the resulting image by using bright lasers source(s). In that application, the inherent characteristics of the laser light, specifically collimation, monochromacity, and speckle, are a source of difficulty and must be eliminated prior to image generation because they lead to significant visual artifacts and image degradations. For this reason, a considerable body of work exists in that field for methods to ensure that resulting area-filling images are free of these optical characteristics (U.S. Pat. Nos. 4,035,068, 6,154,259, 6,323,984, 6,577,429, and 7,193,765).

In contrast, the unique appearance of laser light show images is in part a manifestation collimation, monochromacity, and speckle; the action and interaction of these characteristics on a projection surface helps to aesthetically distinguish these images from those generated by any other natural or technological process.

A long sought-after innovation in the field is a method to generate high-quality stereoscopic 3D vector graphics laser images. Although high-quality stereoscopic 3D techniques have been successfully developed and implemented for conventional area-filling video and cinema displays, development of an analogous method(s) for laser show displays remains elusive. This is because of several technical and practical obstacles that are unique to lasers and the vector graphics scanning method employed in the field of laser light displays.

By definition, any form of stereoscopic 3D must precisely manipulate images in two ways. First, each of the viewer's eyes must see a disparate image in order create perceived depth. The combination of these two disparate images by the viewer, called stereoscopic fusion, produces a single unified 3D percept. Other than the intentionally designed differences in the images, called disparity, which supply the 3D queues, it is important that both images are similar in brightness, hues, and orientation for proper stereoscopic fusion to occur. Often this is attempted by projecting two images, one image intended for the left eye only and a second, corresponding image intended for the right eye only. The technical challenge is to prevent crosstalk, a distracting artifact where each eye unintentionally sees the other eye's image, by using some sort of blocking or filtering methodology.

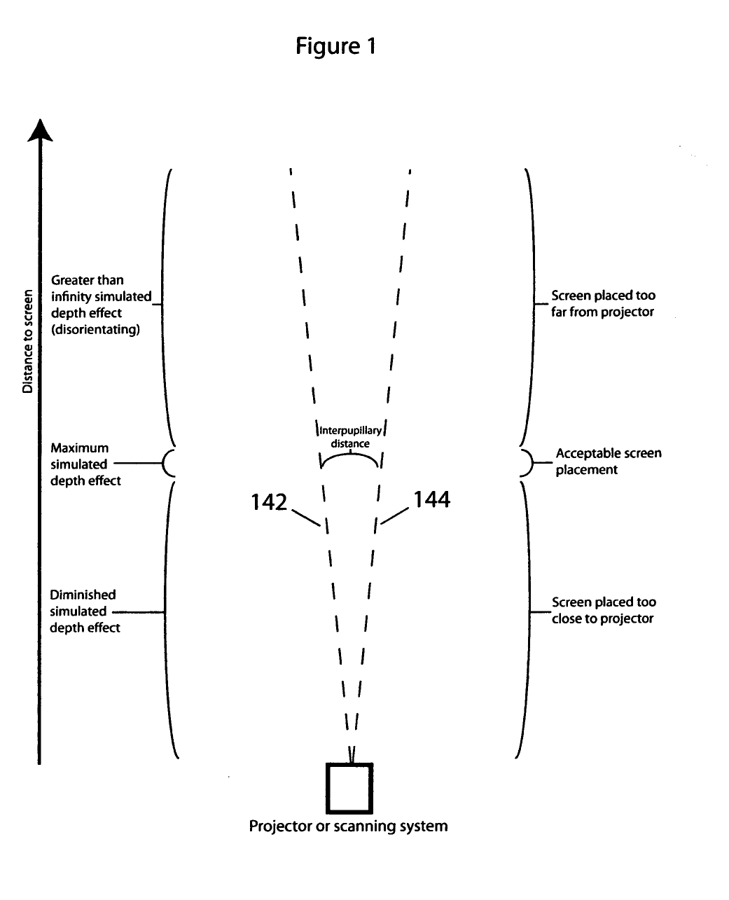

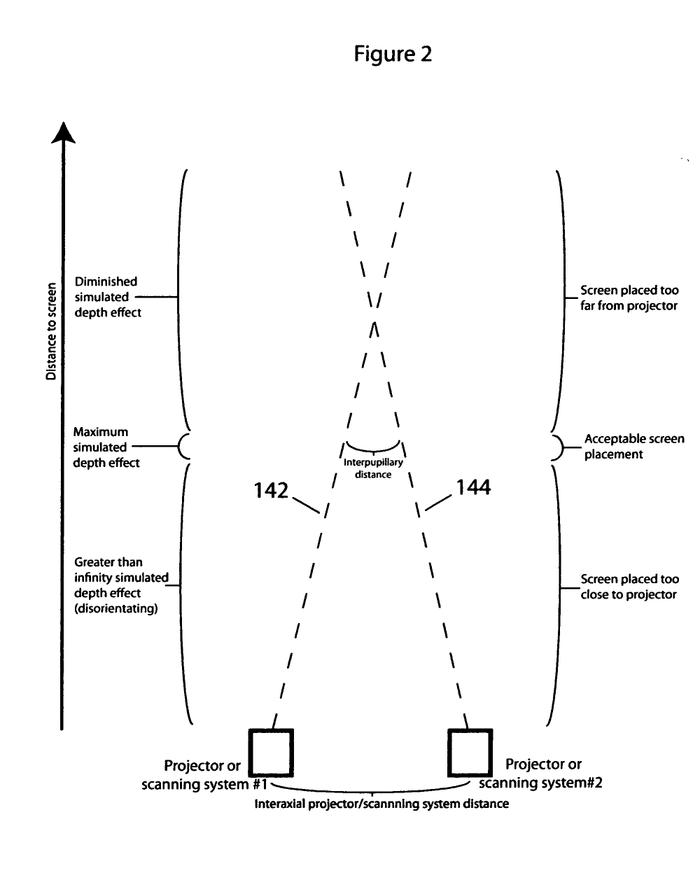

Second, the two images must be properly aligned, relative to one another, usually on a screen or other suitable projection surface, to produce the desired illusion of depth. For dual image stereoscopic displays, proper alignment requires precise calibration of both simulated parallax between each image (which is a function of image size) and the projection distance. These considerations often limit the portability and versatility of such 3D projection systems. For instance, a critical parallax calibration is the image separation that simulates infinite depth. To simulate infinite depth, as seen in FIG. 1, projected light for left eye 142 must intersect a screen, or other viewing surface, such that an image is produced to the left of the image produced by the projected light for right eye 144 by the interpupillary distance for the average viewer. For projection systems that use only a single projector source or scanning system, this imposes a narrow range of acceptable projection distance to the screen. If the screen is too close, the simulated depth effect is diminished. If the screen is too far, the display simulates an image with greater than infinite depth, which is both uncomfortable and disorienting to the viewer. A similar difficulty is present in projection systems that employ two projectors or scanning systems, as seen FIG. 2, particularly because the size of the projectors tends to require a significant interaxial distance between the projectors. Again improper calibration and/or projection distance yield inferior 3D effects.

Although mastery of these two manipulations is sufficient to generate high-quality stereoscopic 3D images for conventional area-filling displays, a third, unique factor must be addressed in the case of vector graphics laser images. This is a consequence of the extremely high contrast inherent to laser show images: typical contrast ratios of laser light displays are several orders of magnitude greater than those of area-filling video and cinema displays. As such, developing an approach that allows for filtering-out of the undesired image from each of the viewer's eyes in order to minimize crosstalk is much more difficult with laser displays. This is the principal reason why, unlike the recent widespread rollout of several high-quality 3D methods in video and cinema, a high-quality stereoscopic 3D methodology for vector graphics scanning laser light displays has remained elusive despite previous attempts.

For example, one method of generating a 3D laser image described in prior art is the use of diffraction grating techniques, including Chromatek's Chromadepth™ (U.S. Pat. Nos. 4,597,634, 4,717,239, and 5,002,364), to convert a single multicolor image into an image with multiple perceived depths. With this technique, color information is coded to correspond to different depths. The wavelengths of the source light determine the relative depths, such that one apparent depth plane is perceived per unique wavelength employed—e.g., red images appear close, green images appear intermediate, and blue images appear distant.

When applied to vector graphics laser displays, this method suffers from a number of limitations. First, the resultant display is not a true 3D, where any apparent depth can be perceived. Only a single depth plane per employed laser wavelength can be simulated, and that plane's depth is fixed. Second, since the perceived depth of an image is a function of the source wavelength, the ability to assign colors in images for purely artistic and/or aesthetic reasons is forfeit, and the source colors cannot be mixed to produce additional hues. Lastly, the high contrast images of vector graphics laser displays, in conjunction with diffraction grating 3D technology, produce highly distracting sideband images from the higher order diffractions. For these reasons, this technology has largely fallen out of favor by practitioners of the art.

Other stereoscopic 3D methods currently in use for video and cinema applications do not lend themselves to vector graphics laser displays. For example, one approach (U.S. Pat. No. 4,978,202) uses light polarization technology, whereby a combination of either linear or circular polarized filters is employed to selectively filter-out images. The intended design is that two images are displayed, each highly polarized orthogonally with respect to the other. The images are then viewed through a pair of filters, which selectively transmit the desired image to each eye, while selectively blocking the undesired images.

Although polarization techniques have been employed successfully for relatively low contrast media (in fact, they are a leading method of displaying 3D for cinema applications), when used in combination with vector graphics laser displays, polarization is plagued by several severe optical and practical limitations. First, the polarization of the source light must be preserved to a very high degree through all of the optics of the laser projector, which imposes stringent design demands and requires more expensive components than would otherwise be needed. Likewise, the fact that the displayed laser light must be highly polarized precludes the use of certain beam combining methods to increase brightness (German patent DE 10 2007 045 845 A1, and U.S. Pat. No. 5,067,799), which are crucial in the performance capability of many modern laser projections systems. Additionally, the screen, or appropriate viewing surface, must be constructed of special materials in order to preserve the polarization characteristics of the incident light, vastly decreasing the utility and versatility of this technique.

Furthermore, the use of polarization techniques to achieve a stereoscopic image also imposes a practical limit to the quality of the images because of the method's inherent nature to always have some degree of crosstalk contamination. Loss of polarization and selectivity, even of just a few percent, from a number of possible sources, including the light source, the projector optics, the projection surface, and the viewing filters (glasses) geometrically increases crosstalk. In practice, the effectiveness of this technique is further decreased by factors such as air-borne particulates or smudges on the viewing filters that degrade the polarization purity of the light. Because image contrast is so high in vector graphics laser displays, any such crosstalk greatly diminishes the desire 3D effect.

A third technique used to produce stereoscopic images for video and cinema applications is active shutter technology (U.S. Pat. Nos. 4,523,226, 4,698,668, 4,884,786, 4,967,268, 5,181,133, and 5,463,428). Active shutter techniques are currently the predominant stereoscopic technology in home theater use and emerging 3D television markets. Typically, they operate with a projection source that alternates between showing one image for the left eye and one for the right eye at a very high rate. When viewed through an appropriate apparatus, such as active shutter glasses, a stereoscopic image is produced. The glasses are synchronized to the projection source so as to cover one eye at a time in rapid succession, only allowing each image to be perceived by the appropriate eye.

Analysis of this technique shows it is ill-suited for viewing stereoscopic vector graphics laser images. The shuttering effect at the core of this approach requires a very high refresh rate. The refresh rate must be high enough to be relatively imperceptible to the viewer and must be synchronized between the image and the filters. However, the refresh rate of typical vector graphics laser images, due to the mechanical scanning that generates them, is typically an order of magnitude lower than that of current 3D televisions. Therefore, applying active shutter technology to vector graphics laser images would result in the viewer perceiving significant image flicker. A further complication is that the refresh rate of a vector graphics laser display often varies from frame-to-frame depending upon the complexity of the scanned image. Therefore, even if the aforementioned issue with flicker could be resolved, the development of a system to maintain perfect synchronization between the varying refresh rate of the laser images and active shutter glasses is currently impractical.

### ADVANTAGES OF THE APPLICATION

This application describes a stereoscopic laser projector compatible with wavelength multiplexing filter technology (U.S. Pat. Nos. 6,283,597 and 12,021,519), which holds a number of advantages over prior art for producing vector graphics laser displays. Unlike diffraction grating processes, including Chromatek's Chromadepth™, stereoscopic displays using wavelength multiplex visualization are not limited to a small number of discrete depth planes. Any apparent depth is accessible irrespective of the color of the source light, permitting color mixing techniques to be employed at any apparent depth. In addition, wavelength multiplex visualization does not produce the distracting higher order sideband images prevalent with diffraction grating techniques.

A projector employing wavelength multiplex visualization is likewise superior to those using polarization techniques for laser display applications. First, polarization of the source light is not restricted; therefore, beam combination techniques using source light polarization, which are commonly employed in the laser industry, are fully compatible with this technique. Likewise, expensive and high-precision optics used to preserve polarization are not required. Most significantly, this application does not require any special polarization preserving screen, greatly increasing the versatility of such a display system. In addition, as this application employs the wavelength multiplex visualization method of producing stereoscopic images, it is not limited by the practical performance ceiling to which polarization techniques are subject. In order to increase the extinction of the undesired image, and thus decrease crosstalk, the overall dichroic layer of viewing filters can be made more robust and thicker, allowing arbitrarily high image selectivity. Hence, this application uniquely takes advantages of the strengths of wavelength multiplex visualization to satisfy the high contrast demands inherent in stereoscopic vector graphics laser displays. This stereoscopic vector graphics laser projector application is particularly advantageous in conjunction with wavelength multiplex visualization because there is very little loss of brightness for the desired image, since only the undesired wavelengths are blocked from each of the viewer's eyes. Transmissions of desired light of 90% or higher are easily attainable with this application, producing bright, high-quality stereoscopic images.

### SUMMARY

In accordance with one embodiment a stereoscopic laser projector compatible with wavelength multiplexing filter technology comprises a scanning system and a plurality of laser systems, such that each output beam of light has a unique wavelength and is similar in hue to at least one other output beam of light. The scanning source receives and deflects the output beams of light to produce images on a projection surface.

### DRAWINGS

### Figures

The present application will become more fully understood from the detailed description given below and by the accompanying figures, which are provided by way of illustration only, and thus are not limitative of the present invention, wherein:

FIG. 1 is a top-down view of the projected light paths from a single projector or scanning system that is calibrated to produce an image with a simulated depth of infinity, and shows the necessary distance between the projector and the screen.

FIG. 2 is a top-down view of the projected light paths from a dual projector or scanning system that is calibrated to produce an image with a simulated depth of infinity, and shows the necessary distance between the projector and the screen.

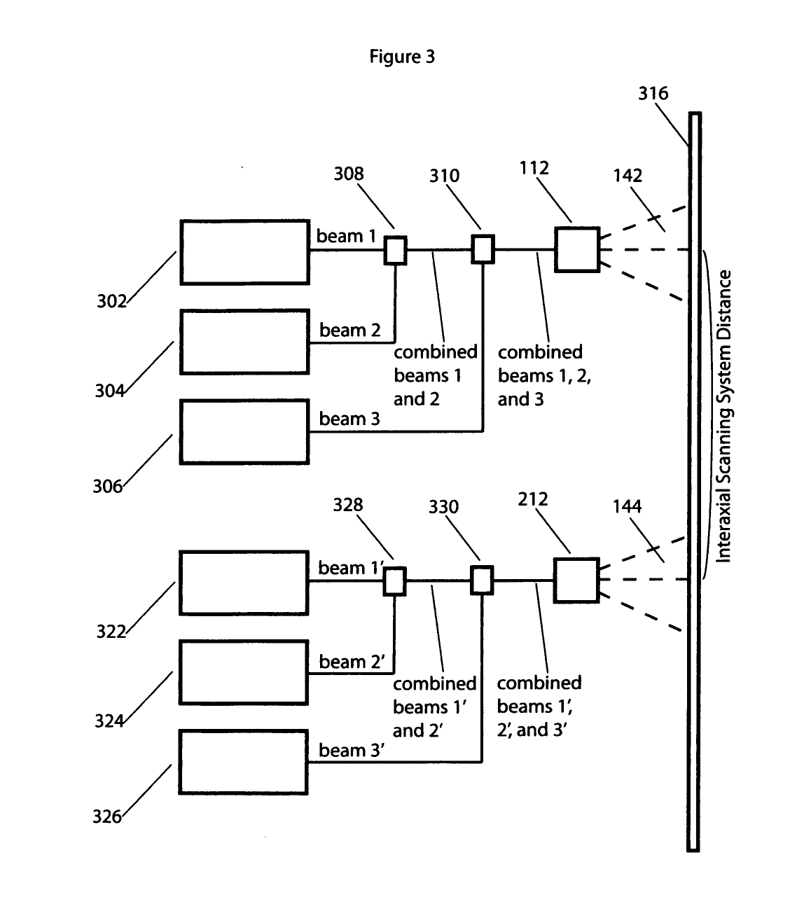

FIG. 3 is a top-down block diagram of the first embodiment of the present application.

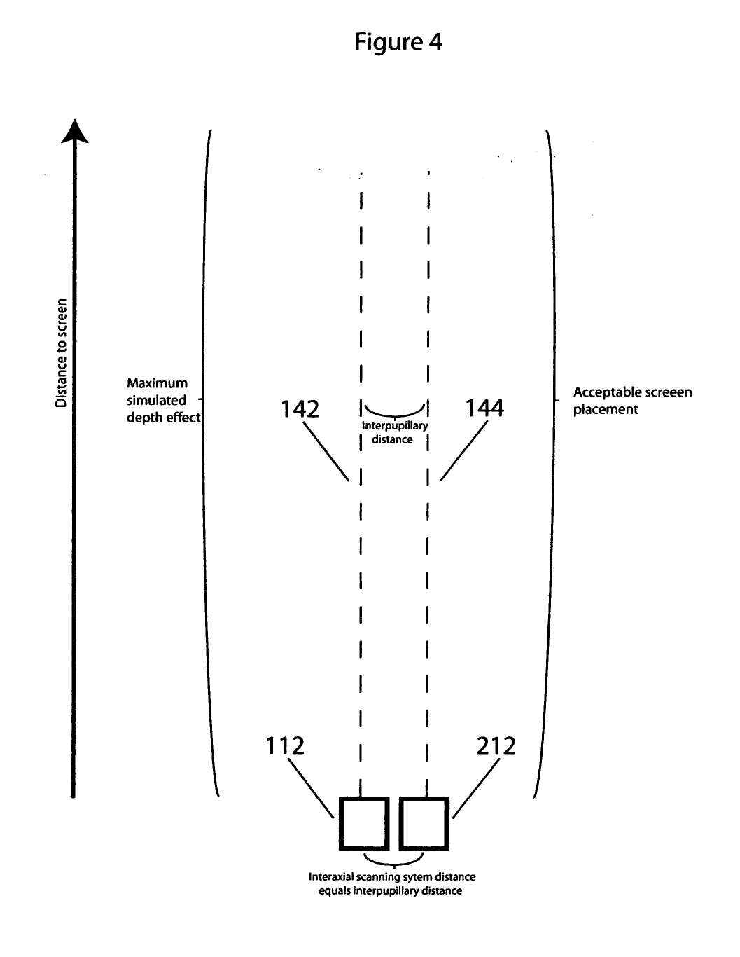

FIG. 4 is a top-down view of the projected light paths from the first embodiment of the present invention that is calibrated to produce an image with a simulated depth of infinity, and shows the screen is not limited to a single distance from the projector to maximize simulated depth effects.

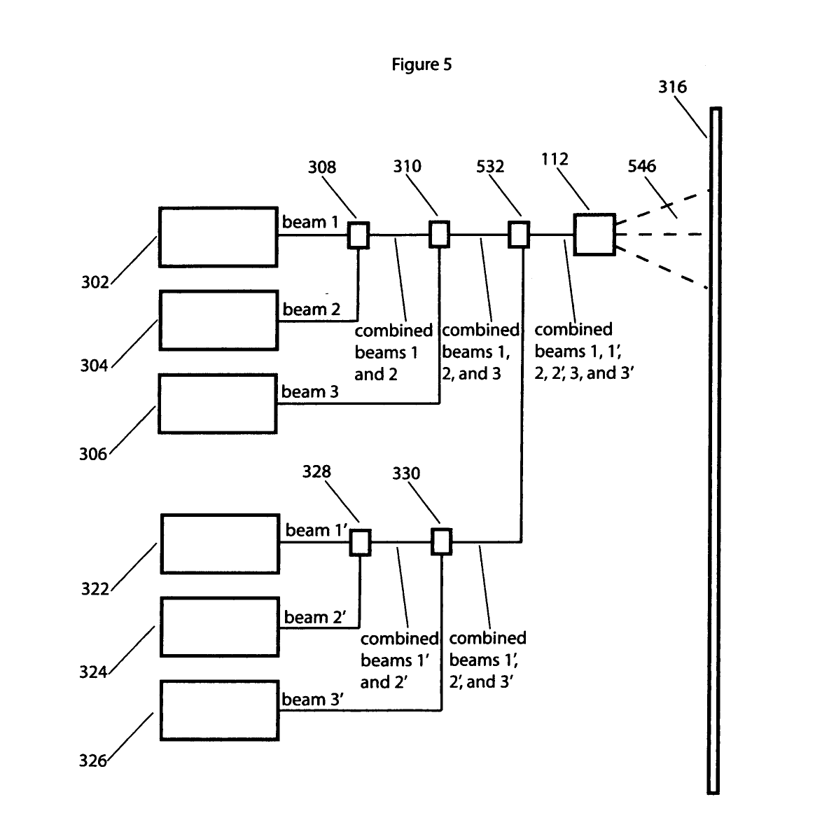

FIG. 5 is a top-down block diagram of the second embodiment of the present application.

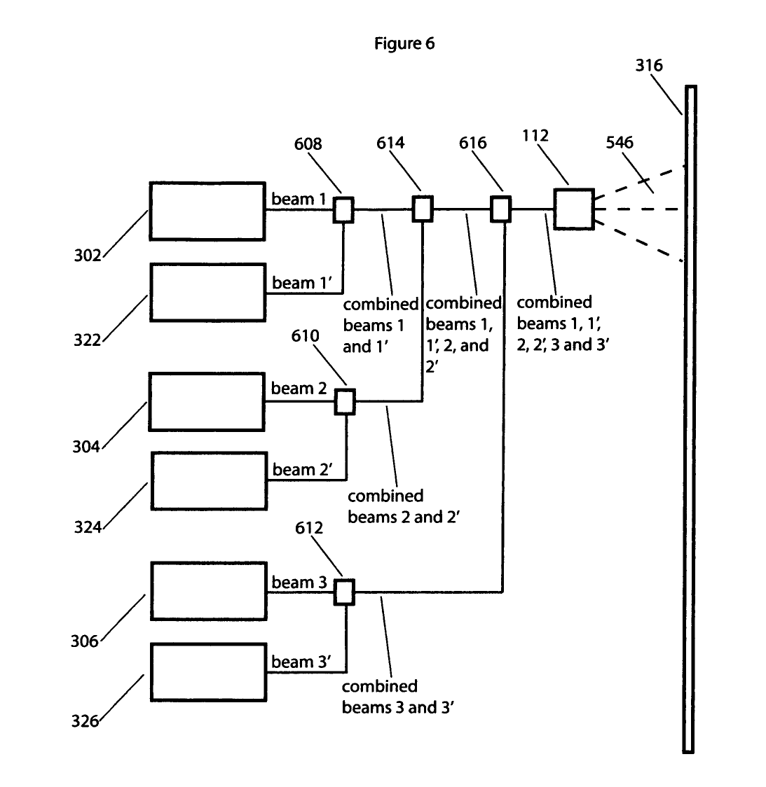

FIG. 6 is a top-down block diagram of the third embodiment of the present application.

### REFERENCE NUMERALS

112 Scanning system #1
212 Scanning system #2
142 Projected light for left eye
144 Projected light for right eye
302 Laser system #1
304 Laser system #2
306 Laser system #3
308 Beam combiner #1
310 Beam combiner #2
316 Screen
322 Laser system #1′
324 Laser system #2′
326 Laser system #3′
328 Beam combiner #1′
330 Beam combiner #2′
532 Beam combiner #3
546 Projected light for each eye
608 Beam combiner G
610 Beam combiner B
612 Beam combiner R
614 Beam combiner GB
616 Beam combiner GBR

### DETAILED DESCRIPTION

### First Embodiment

The first embodiment of the application is illustrated by a top-down block diagram in FIG. 3. Laser system #1 302 is oriented such that its output modulated light beam, labeled beam 1 in FIG. 3, is directed through a beam combiner #1 308. All laser systems described herein can be analog modulated lasers, unmodulated laser light sources in conjunction with external modulators, or any other means of producing a substantially collimated beam of modulated light. The beam combiner #1 308, as well as all other beam combiners mentioned throughout, can be a dichroic lens, polarization beam splitter/combiner, edge combiner, prism, diffraction grating, or any other method of producing substantially overlapping combined light beams from two or more distinct light beams. Laser system #2 304, having an output with a distinct wavelength and hue from that of laser system #1 302, is oriented such that its output modulated light beam, labeled beam 2 in FIG. 3, is directed through the beam combiner #1 308. Combined beams 1 and 2 are directed through a beam combiner #2 310. Laser system #3 306, having an output with a distinct wavelength and hue from that of both laser system #1 302 and laser system #2 304, is oriented such that its output modulated light beam, labeled beam 3 in FIG. 3, is directed through the beam combiner #2 310. Combined beams 1, 2, and 3 are directed through a scanning system #1 112. All scanning systems referred to herein maybe be any means of deflecting the incident light beams using any mechanical, optical and/or electronic methods, including moving mirrors or lenses. The deflection from any scanning system is controlled by an appropriate signal source. The scanning system #1 112 deflects the combined beams 1, 2, and 3 to produce the projected light for left eye 142 onto a screen or other suitable viewing surface 316.

Laser system #1′ 322, having an output with similar hue but distinct wavelength to that of laser system #1 302, is oriented such that its output modulated light beam, labeled beam 1′ in FIG. 3, is directed through a beam combiner #1′ 328. Laser system #2′ 324, having an output with similar hue but distinct wavelength to that of laser system #2 304, is oriented such that its output modulated light beam, labeled beam 2′ in FIG. 3, is directed through the beam combiner #1′ 328. Combined beams 1′ and 2′ are directed through a beam combiner #2′ 330. Laser system #3′ 326, having an output with similar hue but distinct wavelength to that of laser system #3 306, is oriented such that its output modulated light beam, labeled beam 3′ in FIG. 3, is directed through the beam combiner #2′ 330. Combined beams 1′, 2′, and 3′ are directed through a scanning system #2 212. The scanning system #2 212 deflects the combined beams 1′, 2′, and 3′ to produce the projected light for right eye 144 onto the screen 316. Note that any projection surface, or screen, referred to herein can be any viewing surface or object onto which all or some visible fraction of the output beams of light are terminated, scattered, reflected or diffused such that a visual image is produced.

Laser system #1 302, laser system #2 304, and laser system #3 306 are selected such that the visible wavelengths produced are substantially transmitted by a wavelength multiplexing filter in front of a viewer's left eye, while the wavelengths are substantially blocked by a different wavelength multiplexing filter in front of the viewer's right eye. In addition, laser system #1 302, laser system #2 304, and laser system #3 306 are selected such that red, green, and blue hues are produced, allowing the projected light for left eye 142 to simulate a full-color palette.

Likewise, laser system #1′ 322, laser system #2′ 324, and laser system #3′ 326 are selected such that the visible wavelengths produced are substantially blocked by the appropriate wavelength multiplexing filter in front of a viewer's left eye, while the wavelengths are substantially transmitted by the appropriate wavelength multiplexing filter in front of the viewer's right eye. Also, laser system #1′ 322, laser system #2′ 324, and laser system #3′ 326 are selected such that the hues produced are similar to those produced from laser system #1 302, laser system #2 304, and laser system #3 306, allowing the projected light for right eye 144 to simulate a full-color palette that is similar in nature to the colors in the projected light for left eye 142.

The projected light for left eye 142 and the projected light for right eye 144 are projected onto screen 316 such that the distance between corresponding portions of the images produced varies so as to simulate a depth effect when viewed through appropriate wavelength multiplexing filters.

Note that for this and all subsequent embodiments, additional bounce mirrors or other methods of directing the light beams may be employed as desired and are not shown in FIG. 3. Likewise, fewer laser systems can be employed than are shown in FIG. 3 for any embodiment if any laser system produces more than a single useable wavelength light beam or if three distinct hues of light are not required for a given application.

One additional advantage of this embodiment is that the distance between the scanning systems, called interaxial scanning system distance, can be made equal to the interpupillary distance of the average viewer. As seen in FIG. 4, when the scanning system #1 112 and the scanning system #2 212 are calibrated to simulate infinite distance, the projected light for left eye 142 and the projected light for right eye 144 paths are parallel, making the acceptable range of screen distance much larger. In addition, it is essentially impossible to errantly simulate a depth greater than infinity, thereby avoiding the disorienting and unpleasant artifacts to which any other projector with a different geometry is subject.

### Second Embodiment

The second embodiment of the application has several notable differences from the first embodiment, as illustrated by a top-down block diagram in FIG. 5. In this embodiment, combined beams 1, 2, and 3 are directed through a beam combiner #3 532. Similarly, combined beams 1′, 2′, and 3′ are directed through the beam combiner #3 532, producing combined beams 1, 1′, 2, 2′, 3, and 3′, which are directed through the scanning system #1 112. The scanning system #1 112 deflects the combined beams 1, 1′, 2, 2′, 3 and 3′ to produce the projected light for each eye 546 onto the screen 316. Portions of the projected light for each eye 546 are selectively filtered or transmitted by the wavelength multiplexing filters in front of each of the viewer's eyes, producing a stereoscopic image with simulated depth. Hence, this embodiment produces a stereoscopic image from a single scanning system.

### Third Embodiment

The third embodiment of the application is similar to the second embodiment in that all light beams are combined and then directed to the scanning system #1 112, which then produces stereoscopic images in the same manner as describe above. However, the order of beam combination is notably different in that output modulated light beams with similar hues are combined with each other first, before being combined with output modulated light beams of different hues. Thus the output modulated light beams from laser system #1 302 and from laser system #1′ 322 (which may both be hues of green, by means of example) are directed to and combined via a beam combiner G 608. Output modulated beams the from laser system #2 304 and #2′ 324 (which may both be hues of blue, for instance) are similarly combined by a beam combiner B 610, and output modulated beams from laser system #3 306 and #3′ 326 (which may both be hues of red, in this example) are combined by a beam combiner 612. The combined beams 1 and 1′ (green) and the combined beams 2 and 2′ (blue) are directed to a beam combiner GB 614. The combined beams 1, 1′, 2, and 2′ (green and blue) and the combined beams 3 and 3′ (red) are directed to a beam combiner RGB 616. The overall combined beams 1, 1′, 2, 2′, 3, and 3′ (green, blue, and red) are directed to the scanning system #1 112 as previously described.

### CONCLUSIONS, RAMIFICATIONS, AND SCOPE

Thus the reader will see that at least one embodiment of the laser projector provides a versatile device that produces stereoscopic vector graphics displays in a reliable and pleasing way. While the above description provides many specificities, these should not be construed as limitations on the scope, but rather as a exemplification of several embodiments thereof. Many other variations are possible. For example, laser systems that produce multiple useable wavelengths can be employed. Likewise, a viewing screen, or projection surface, can be incorporated directly into the projector, rather than remotely located. Also, a projector could employ more than two scanning systems. In addition, output beams of light from the laser systems can be directed to the scanning systems such that the projected light for the left eye and the projected light for the right eye each are directed through a plurality of scanning systems. Accordingly, the scope should not be determined by the embodiments illustrated, but by the appended claims and their legal equivalents.

What is claimed is:

1. A method for stereoscopic 3D image representation on a projection surface, comprising the steps of:
a. producing a plurality of substantially collimated and modulated output beams of light, each having a substantially unique wavelength, such that said output beams of light can be differentially filtered by proper wavelength multiplexing filters; each said output beam of light having a complementary output beam of light, such that their wavelengths are substantially similar to each other, such that the visible hue of each said output beam of light is substantially alike in appearance, whereby when viewed through said proper wavelength multiplexing filters a stereoscopic fusion of images can occur; and
b. producing a method of receiving and scanning said output beams of light, such that they are deflected to produce images on a projection surface.

2. A stereoscopic laser projector compatible with wavelength multiplexing filter technology comprising:
a. a plurality of laser systems wherein each laser system produces a substantially collimated and modulated output beam of light having a substantially unique wavelength, such that said output beams of light can be differentially filtered by proper wavelength multiplexing filters;
each said laser system being paired with a corresponding second laser system, such that said output beam of light from the first laser system has said wavelength substantially similar to the wavelength of the output beam of light from the second laser system, such that the visible hue of each output beam of light is substantially alike in appearance, whereby when viewed through said proper wavelength multiplexing filters a perceived fusion of images can occur;
b. a scanning means;
c. said laser systems' output beams of light directed to said scanning means, such that said scanning means can receive and deflect said output beams of light to produce images on a projection surface.

3. The laser projector as recited in claim 2 wherein said scanning means comprises a signal source and a scanning system.

4. The laser projector as recited in claim 2 wherein said scanning means comprises a pair of signal sources and a pair of scanning systems, such that one output beam of light from each laser system pair is received and deflected by each scanning system.

5. The laser projector as recited in claim 4 wherein said scanning systems have a separation from each other substantially equal to the interpupillary distance of the average viewer.

6. The laser projector as recited in claim 2 wherein said scanning means comprises a plurality of signal sources and a plurality scanning system.

7. The laser projector as recited in claim 2 wherein said laser systems are such that the said output beams of light comprise primary colors, whereby combination of said output beams of light can produce a substantially full-color palette.
